(19) United States
(12) Patent Application Publication
(10) Pub. No.: US 2014/0032321 A1
(43) Pub. Date: Jan. 30, 2014

(54) VALUING AUDIENCE DATA

(71) Applicants: Jonathan Michael KRAFCIK, Los Gatos, CA (US); Oren Eli ZAMIR, Los Gatos, CA (US); Ting LIU, Sunnyvale, CA (US); Ching LAW, Hong Kong (CN); Wei YE, San Jose, CA (US)

(72) Inventors: Jonathan Michael KRAFCIK, Los Gatos, CA (US); Oren Eli ZAMIR, Los Gatos, CA (US); Ting LIU, Sunnyvale, CA (US); Ching LAW, Hong Kong (CN); Wei YE, San Jose, CA (US)

(21) Appl. No.: 13/766,023

(22) Filed: Feb. 13, 2013

(30) Foreign Application Priority Data
Jul. 24, 2012 (IL) 221094

(51) Int. Cl. G06Q 30/02

(52) U.S. Cl. CPC G06Q 30/0275
USPC 705/14.54; 705/14.66; 705/14.53

(57) ABSTRACT

Systems, apparatus, and methods allow for revenue sharing between data providers and web page publishers. In one aspect, a computer-implemented method includes: receiving a request for alternative content based on a request for content; receiving user identifier data from at least one data provider; selecting at least one first alternative content from a first pool of alternative content that is contextually related to the requested content; determining a first cost of the at least one first alternative content; selecting, by at least one processing circuit, at least one second alternative content from the first pool, and from the second pool of alternative content that is related to the user identifier data; determining a second cost of the at least one second alternative content; and determining a pricing value of the user identifier data based on a difference between the second and the first costs.

### RELATED APPLICATIONS

The present application claims foreign priority to Israeli Patent Application No. 221,094, entitled “VALUING AUDIENCE DATA” and filed on Jul. 24, 2012.

### BACKGROUND

This specification relates generally to advertising, and particularly to revenue sharing associated with advertising.

The Internet provides access to a wide variety of resources, such as video files, audio files, pictures, business and personnel contact information, product information, maps, and news articles. Access to these resources presents opportunities for advertisements to be provided with the resources.

### SUMMARY

In illustrative implementations, a computer-implemented method includes receiving, by at least one processing circuit, a request for alternative content based on a request for content. The method also includes receiving, by at least one processing circuit, user identifier data from at least one data provider. The method further includes selecting, by at least one processing circuit, at least one first alternative content from a first pool of alternative content that is contextually related to the requested content. The method also includes determining a first cost of the at least one first alternative content. The method additionally includes selecting, by at least one processing circuit, at least one second alternative content from the first pool, and from the second pool of alternative content that is related to the user identifier data. The method yet further includes determining a second cost of the at least one second alternative content. The method also includes determining a pricing value of the user identifier data based on a difference between the second and the first costs.

In other implementations, a computer system for performing an auction for at least one advertisement slot on a web page published by a publisher may include at least one processing circuit connected to a network. The at least one processing circuit is configured to receive a request for advertisements based on a request for the web page and to receive user identifier data from at least one data provider. The at least one processing circuit is also configured to conduct a first auction among a first pool of advertisements, wherein the first pool of advertisements are selected based on their contextual relevance to the web page and to determine, based on the first auction, a media value provided by the publisher. The at least one processing circuit is further configured to conduct a second auction among the first pool and a second pool of advertisements. The second pool of advertisements are selected based on the user identifier data. The at least one processing circuit is configured to determine, based on the second auction, an overall advertisement value provided by both the at least one data provider and the publisher. The at least one processing circuit is also configured to determine a pricing value of the user identifier data based on a difference between the overall advertisement value and the media value.

In further implementations, a computer-readable storage medium has instructions stored thereon which, when executed, cause at least one processing circuit to perform an auction for at least one advertisement slot on a web page published by a publisher. The instructions include receiving a request for advertisements based on a request for the web page and receiving user identifier data from at least one data provider. The instructions also include conducting a first auction among a first pool of advertisements, the first pool of advertisements being selected based their contextual relevance to the web page. The instructions further include determining, based on the first auction, a media value provided by the publisher and conducting a second auction among the first pool and a second pool of advertisements. The second pool of advertisements are selected based on the user identifier data. The instructions yet further include determining, based on the second auction, an overall advertisement value provided by both the at least one data provider and the publisher and determining a pricing value of the user identifier data based on a difference between the overall advertisement value and the media value. The instructions also include displaying the web page including at least one advertisement based on the second auction and sharing a revenue from said displaying between the publisher and the at least one data provider.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, implementations, and features of the present teachings can be more fully understood from the following description in conjunction with the accompanying drawings.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a diagram illustrating an example of a content requesting and rendering system, such as in an advertising environment.

FIG. 2 is a block diagram of an example of a webpage of a publisher, including a plurality of advertisements including contextual advertisements and user advertisements, as appeared on a viewer's screen.

FIG. 3 is a block diagram of an example of a webpage that may be generated by a page assembly operation of an advertisement consumer, for rendering on a viewer's screen.

FIG. 4 is a flowchart illustrating some examples of the various operations.

FIG. 5 is a flowchart illustrating an example method of differentiating different contributions through a plurality of layered auctions.

FIG. 6 is a flowchart illustrating an example method of rewarding different data providers based on their respective contributions.

FIG. 7 is a block diagram illustrating an example of a computer system that can be used to perform at least some of the various operations.

### DETAILED DESCRIPTION

Below are more detailed descriptions of various concepts related to, and implementations of, inventive methods and systems for revenue sharing in an advertising environment. It should be appreciated that various concepts introduced above and discussed in greater detail below may be implemented in any of numerous ways, as the disclosed concepts are not limited to any particular manner of implementation. For example, the content rendering and data attribution methods are not limited to revenue sharing in advertising, but may be applied to any other content. Examples of specific implementations and applications are provided primarily for illustrative purposes.

A web page such as a search result page provided by a search engine server, or any web page provided by a publisher, can include slots in which alternative content items (e.g., advertisements) can be presented. These advertisements slots can be defined in the web page or defined for presentation with a web page, for example, as part of the webpage, or in a pop-up window, for presentation to users. As used herein, a “user” may refer to an identifier of an individual user, a user device, a user browser, etc., and does not necessarily refer to the actual individual user. The identifiers may include cookies, for example. The cookies can include activity data for more than one user, and one user can have several cookies (e.g., on different machines, different browsers, different times, etc.). Users may opt out of data collection, and users may opt in to provide additional demographic data for improved online experience. The identifiers associated with user data may be anonymized and not connected to user names or actual identifies, or other sensitive information.

Advertisement slots can be allocated to advertisers through an auction. For example, advertisers can provide bids specifying monetary amounts which the advertisers are respectively willing to pay for presentation of their advertisements. In turn, an auction can be performed and the advertisement slots can be allocated to advertisers according to their bids. When one advertisement slot is being allocated in the auction, the advertisement slot can be allocated to the advertiser that provided the highest bid or a highest auction score (e.g., a score that may be computed as a function of a bid and/or an advertisement quality measure, where the advertisement quality measure can be how well the content of the advertisement matches searches for certain keywords). When multiple advertisement slots are allocated in a single auction, the advertisement slots can be allocated to a set of bidders that provided the highest bids or advertisements having the highest auction scores.

The advertising can be part of Internet marketing (also known as online marketing, web marketing, or e-marketing). The effectiveness of online marketing can be measured by cost per impression (CPI), or cost per thousand impressions (CPM), where an impression may be counted for example whenever an advertisement server counts a loading on an advertisement onto a user's screen. Some of the impressions lead to user identifiers' clicking on the advertisement, and a click-through rate (CTR) may be defined as the number of clicks on the advertisement divided by the number of impressions.

Some of the user identifiers visiting the webpage may take a desired action beyond simple browsing (impression) of the webpage. The desired actions may include, for example, buying a product from the webpage, joining a membership, opening an account, subscribing a newsletter, downloading an application, user identifiers' referring the advertisement to other user identifiers, etc. The percentage of such visitors taking the desired actions may be referred to as the conversion rate. Thus, advertisement pricing sometimes can be more accurately determined by cost per action (CPA).

Correspondingly, the advertisement pricing may be measured as cost per click-through (CPC; counted when an advertisement is clicked), cost per sale (CPS), and cost per lead (CPL).

Sometimes an effective CPM (eCPM) may be used to measure the effectiveness of an advertisement, where actual actions such as clicks may be factored into the calculation of the CPM described above.

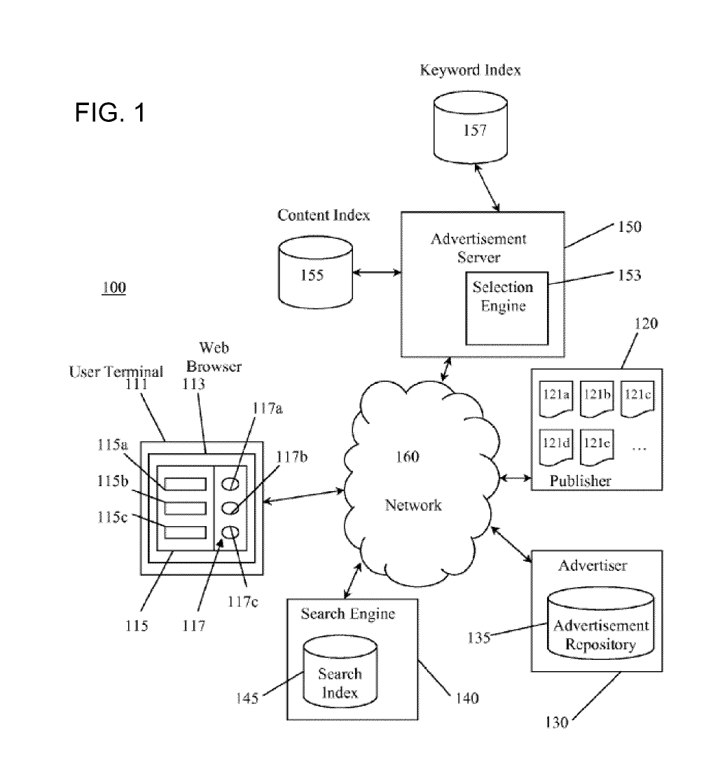

FIG. 1 illustrates an example of a system 100 for distributing content, such as web page content, search results, and alternative content such as advertisements. The system 100 may include a user identifier terminal 111 to which content is distributed, and a publisher 120 that provides content 121a-121e, such as web pages, that include space to which alternative content can be distributed.

A search engine provider 140 may be operable to assist user identifiers in finding desired content in response to user-generated search queries using a search index 145 stored on one or more storage devices. The system 100 may also include a content provider 130, such as an advertiser, that provides alternative content for distribution to user identifiers, and a content server 150 for selecting alternative content (e.g., advertisements) distribution to available spaces included in publishers' content, or other requested content.

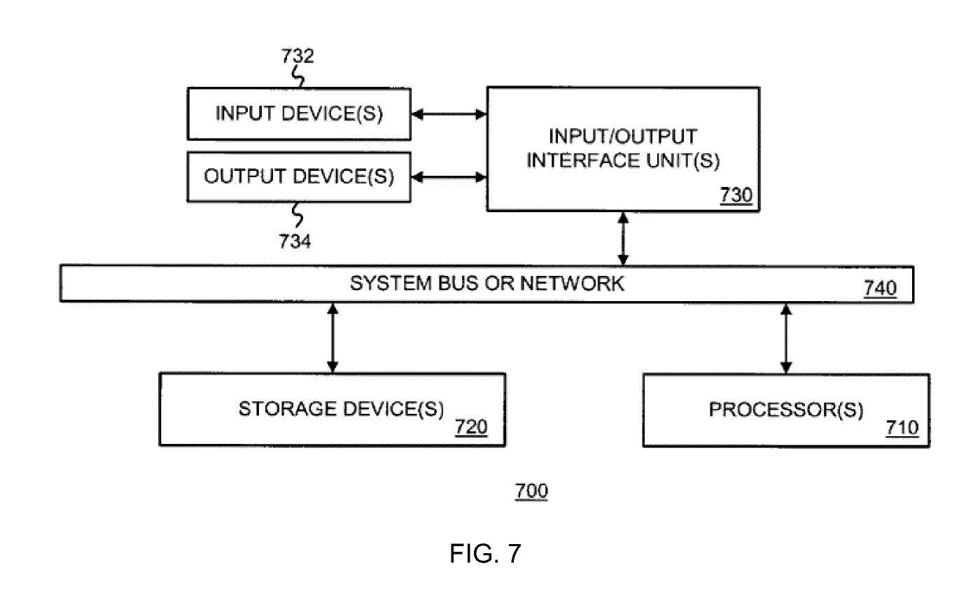

One or more of the components of the system 100, such as the user identifier terminal 111, the publisher 120, the content provider 130, the search engine provider 140, and/or the content server 150, can include or be connected to one or more computer systems, as described in detail below with respect to FIG. 7.

The user identifier terminal 111 can include a personal computer, a mobile device, and/or another computing device capable of communicating with the publisher 120, the content provider 130, the search engine provider 140, and/or the content server 150 via the network 160 and capable of displaying content, including selected alternative content, to a user identifier. In some implementations, the user identifier terminal 111 includes a user identifier interface 113, such as an Internet browser program, that is operable to output a display to the user identifier and/or to receive inputs from the user identifier, such as keystrokes, pointer clicks, voice commands, and/or another inputs. The display of the user identifier interface 113 can include a first area 115 for display of content 115a-115c from a first source, such as search results provided by the search engine provider 140 or the a web page 121a provided by the publisher 120.

The display of the user identifier interface 113 can also include a second area 117 for display of alternative content 117a-117c from a second source, such as advertisements selected by the content server 150 from among available advertisements provided by one or more content providers 130.

The publisher 120 can include a server computer or another computing device that may include a storage device on which the pieces of content 121a-121e are stored. The publisher 120 can receive requests for content from the user identifier terminal 111 and to transmit one or more computer files and/or data streams in response to each request. In some implementations, the pieces of content 121a-121e may include current contexts of web pages, which are transmitted to the user identifier terminal 111 in response to a real-time request over the network 160, which may include the Internet.

The user identifier interface 113 can process the computer files and/or data streams to create an audio/visual display of the content of a requested web page. One or more of the computer files and/or data streams may include one or more instructions that, when processed by the user identifier terminal 111, can cause the user identifier terminal 111 to request one or more pieces of alternative content from the content server 150.

In response to receiving the request for alternative content, a selection engine 153 of the content server 150 selects an appropriate number of pieces of content for distribution to the user identifier terminal 111 from among candidate pieces of content referenced in one or more indices, such as indices 155 and 157. In some implementations, the index 157 may be a keyword-based index that can be used to select pieces of alternative content based on keywords included in the request, and the index 155 may be a content-based index which can be used to select pieces of alternative content based on the content 115a-115c requested from the publisher 120, as indicated in the request for alternative content.

With respect to selecting one or more pieces of alternative content in response to a request for alternative content, the content server 150 can operate, in some implementations, like advertising systems based on third-party publishing and/or based on online searching. In other implementations, however, the content server 150 can select alternative content in other ways.

Generally, the content-based index 155 may include references between available pieces of alternative content and locations associated with publishers' content, such as web page addresses for web pages 121a-121e. The references may be determined by the content server 150 based on contextual relationships between the publishers' content available at the locations and available pieces of alternative content. The context of the publishers' content and the available pieces of alternative content may be determined based on an analysis of the content of each performed by the content server 150. For example, in an advertising environment, a copy of a web page 121a may be parsed to identify the context of the web page 121a from text, hypertext links, metadata of images, audios, and videos, and other content included in the web page 121a. Additionally, other signals, such as a frequency of occurrence of a text phrase, or whether the text phrase appears as a title, can be used in determining the context of the web page 121a. Many other signals may also be used in determining the context of the web page 121a.

The context of available advertisements can also be determined, and matching contexts can be indicated in the content-based index 155. For example, the content provider 130 can provide, for each advertisement, selected context categories with which the advertisement is related. Additionally, or alternatively, other signals of contextual relevance can be used to determine the context of the advertisements, such as historical performance information regarding user identifier interaction with the advertisements and the contexts of the web pages on which the advertisements appeared when an interaction occurred.

In a simple example, the content-based index 155 may include, for each web page, such as the web page 121a, a ranked list of advertisements to be delivered to a reserved advertisement area of the web page. The ranked list can be updated, such as when the content of the web page changes and/or as advertisements are added or removed from the index, or as the context of the advertisements change.

The keyword-based index 157 also generally can include references between the available pieces of alternative content and the publishers' content. For example, continuing with the advertising environment, the keyword-based index 157 may include bids on keywords provided by advertisers for each advertisement, as well as indications of which keywords match each of the web pages 121a-121e of the publisher. Similar information can be maintained for each publisher that may use the content server 150 to select advertisements for display on the publisher's web pages. Thus, keywords included in a request, such as keywords included in or derived from a search query, can be used to identify advertisements that have matching keyword bids. If the request does not include keywords, then the keywords matching the web page associated with the request can be used to identify advertisements that have matching keyword bids. Advertisements for distribution to the web page may be selected from among the identified advertisements that have bids for keywords matching those included in the request or associated with the web page.

Regardless of the specific operation processes of the content server 150, an indication of the selected alternative content may be transmitted to the user identifier terminal 111 in response to the request for alternative content. The response may include instructions that, when executed by the user identifier terminal 111, can cause the user identifier terminal 111 to request a copy of the selected alternative content from the content provider 130. In response to receiving the request for the selected alternative content, the content provider 130 transmits one or more computer files or data streams to the user identifier terminal 111 that enable the user identifier terminal 111 to output an audio and/or video display of the selected alternative content. In some implementations, the computer files or data can be stored on a storage device 135, which may include a repository for such files or data. If the content provider 130 is an advertiser, the storage device 135 may include an advertisement repository. In some implementations, the content files or data associated with the candidate pieces of alternative content can be stored on a storage device of the content server 150.

As discussed above, however, in some instances, the current context of the requested content 115a-115c at the time of a request for alternative content 117a-117c for display with the requested content 115a-115c may not be known. For example, if the content located on the web page 121a has changed subsequent to the most recent review of the web page 121a by the content server 150, then the context of the web page 121a indicated in the content-based index 155 may be inaccurate. Consequently, advertisements, or other alternative content, selected based on the context of the web page 121a indicated in the content-based index may not be contextually-relevant to the current content of the web page 121a. As a result, the selected advertisements, or other alternative content, may not be interesting or useful to the user identifier. Similarly, the current context of a search results web page generated by the search engine 140, which may include little or no content besides the search results themselves, is also unlikely to be reflected in the content-based index 155 because the search results page may not have previously been available for analysis by the content server 150. Even for very popular search queries, where some or all of the search results may be stored, such as in a cache, for use in responding to subsequent searches, and where the stored search results have been analyzed by the content server 150 for use in selecting advertisements to include along with the search results, the current context of the search results may have changed subsequent to the last review by the content server 150.

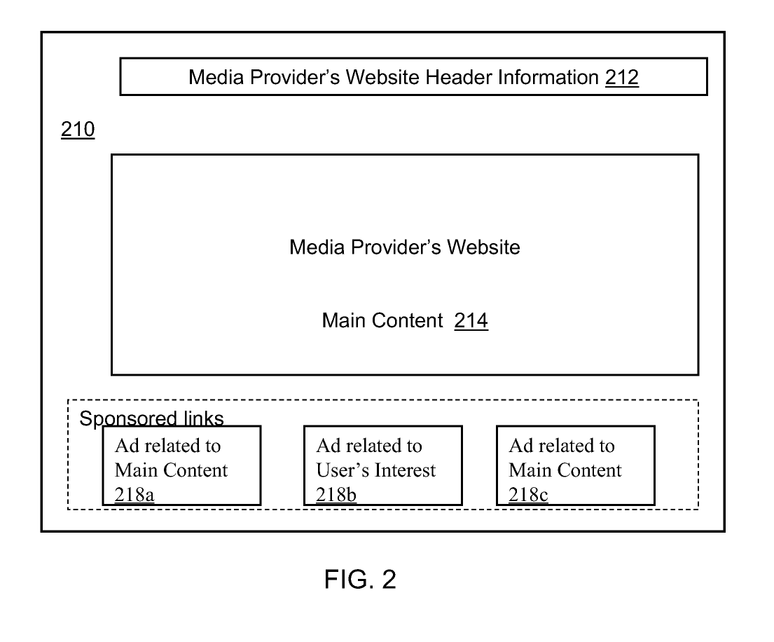

In many different environments, content providers such as advertisers may want to distribute content to selected individuals for review. For example, advertisers may want to distribute their advertisements where the advertisements will be effective in communicating information to receptive recipients, and at times when the advertisements will lead to desired activity, such as a purchase of the advertiser's goods or services. FIG. 2 shows an abstract illustration of a display page 210 that may be provided by a publisher (media provider). The example display page 210 may include header information 212 (e.g., the name of the media provider), main content 314, and a plurality of advertisements 218a, 218b, and 218c. Advertisements 218 may be shaded, labeled as “Advertisements” or “Sponsored Links,” and placed on a side or portion of the display page 210. Although FIG. 2 shows only three advertisements 218, various implementations may have more or less advertisements.

Some content providers/advertisers may rely on contextual information when making decisions regarding content distribution selections. As illustrated in FIG. 2, advertisements 218a and 218c may be such contextual advertisements, and may be contextually related to the main content 214. For example, advertisers may want to advertise goods and/or services relating to travel where information of general interest to travel enthusiasts is available, and may prefer to have their advertisements shown based on that the display page 210 is related to travel. Although advertisements 218a and 218c may be considered as “static” advertisements that only contextually correlate to the main content 214 (which may be relatively static), they may be considered as displayed in response to a real-time, express indication of a topic of interest by the end user identifier (e.g., the user identifier's very action of viewing the display page 210).

Some other advertisers may prefer relying on specified information, such as user identifiers' interests based on their browsing histories, or demographic information of recipients, when selecting advertisements for distribution. For example, the user identifier viewing the display page 210 may have previously visited a fiction site. Such information (user identifier data) may be provided by the fiction site (data provider). Of course user identifiers may opt out of data collection, or may optionally provide additional demographic data. In general, at least the user identifier IDs may be anonymized and not connected with user names to protect user identifiers' privacy.

Based on such user identifier data, an advertisement 218b related to fictions may be shown based on the user's interest. Unlike the advertisements 218a and 218c, the advertisement 218b may be displayed based on the user's historical behavioral data provided by the data provider, and can be more dynamic. The display of the advertisement 218b may not be in response to an express indication of a topic of interest by the user identifier such as the current view of the web site or a submission of a search query. In this implementation, third-party advertising may be implemented with user identifier historical behavioral data, and the advertisements 218 can include both those related to the user's current interest (e.g., the current context of the main content of the display page 210 which the user identifier is browsing), and those related to the user's other interest as derived from the historical user identifier behavioral data.

Some of the user identifier data may include user identifier demographic data. For example, some advertisements may be delivered to user identifiers at a certain geographic location based on user identifier data such as their IP addresses. These advertisements are also generally referred to as “user advertisements.”

In some other implementations, the alternative content is not limited to advertising, but can be any content that may have a value.

Additionally, content providers can rely on performance information regarding results achieved by previous content distribution selections.

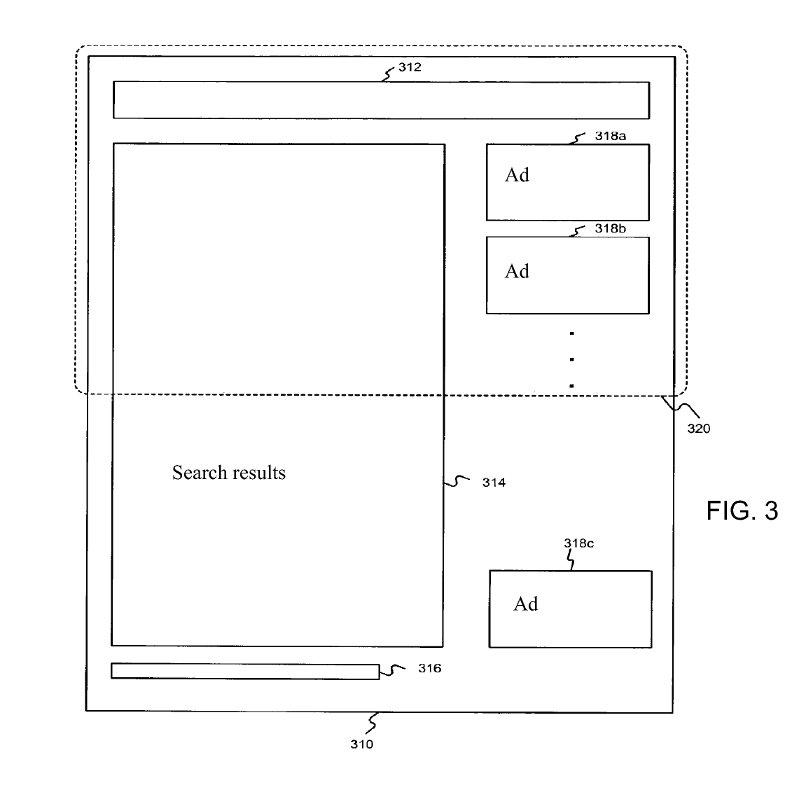

In some other implementations, the search engine may combine the search results with one or more of the advertisements. This combined information including the search results and advertisement(s) can then be forwarded towards the user identifier that requested the content, for presentation to the user identifier. For example, FIG. 3 shows an abstract illustration of a display page 310 that may be provided by the search engine. In this case, the search engine provider is also the publisher/media provider. The effectiveness of contextual advertisements illustrated in FIG. 3 may be limited to when a user identifier enters a search query to indicate their current topic of interest.

In some implementations, user advertisements can also be included in the display page 310, similar to those advertisements selected based on user identifier interests from user identifier behavioral data as illustrated in FIG. 2. In one example, the user advertisements may be based on user identifier locations derived from user identifier IP address data provided by IP providers. In another example, the user advertisements may be based on the user's past searches, and the data provider can be the search engine provider itself, which also is the publisher of the current context of the web page reflecting the user's current search/interests.

The outline 320 depicted with dashed lines corresponds to a portion of the display page 310 that may be viewed on a typical personal computer display screen. The example display page 310 may include header information 312 (e.g., the name of search engine host), trailer information 316 (e.g., copyright, navigational hypertext links, etc.), a plurality of search results 314 and a plurality of advertisements 318a, 318b, and 318c. The search results 314 may be maintained or displayed as distinct from the advertisements 318, so as not to confuse the user identifier between paid advertisements and presumably neutral search results. For example, advertisements 318 may be shaded, labeled as “Advertisements” or “Sponsored Links,” and placed on a side or top portion of the display page 310. Although FIG. 3 shows only three advertisements 318, various implementations may have more or fewer advertisements. For example, ten search results combined with ten advertisements can be shown. This number may depend on the search results, the amount of screen or page space occupied by the search results, the size and shape of the advertisements, etc.

For the user identifiers, there may be no difference in the appearance of the main content of the web pages. On the backside, the revenue obtained from the advertisers can be split with between the website publisher (e.g., 68%) and the search engine provider (e.g., 32%). Other advertisers and website publishers may have user identifier data available. Such data provider may wish to make their data available to a search engine provider or an advertisement network, so that another advertiser or publisher could use these data to more efficiently allocate their advertisements to particular user identifiers or sites, or use these data for advertisement optimization.

However, often not many (e.g., less than 30%) of all advertising activities make use of these data. It may be because these data are often mis-priced, e.g., priced above or below the value it is generating for advertisers. In addition, it may be difficult to determine the value of data, such as the historical user identifier behavioral data provided by the data provider. User identifier data may also be different from other types of resources, such as media (website) provided by a publisher. For example, data can often be considered privileged. Data sources can be scarce if user identifiers are not able or allowed to copy them. Data may be restricted for example due to legal, contractual, or use/business rule restrictions.

Without the knowledge of the value of the user identifier data, an advertisement delivering system may include the following operations: 1) Retrieve and score advertisements based on their contextual relevancy to a publisher's webpage content; 2) Rank advertisements, for example using eCPM, and pick the top N advertisements to show; 3) Run a second-price auction, and charge advertisers based on their types of specified advertisement deliveries; and 4) Share revenue between the advertisement delivering system provider and the publisher.

In this scenario the publisher may be providing two sets of values to advertisers, including the content of the page which may be used to find the relevant advertisements, and advertisement placements for advertisements to show upon. That is, the publisher may act both as a data provider, and a media provider. The data in this case may refer to the current interest of the user, as immediately known from the user's viewing of the current context of the content of the webpage. The media here may refer to the publishing service.

However, with the expansion of various methods for delivering more relevant content items to user identifiers (such as interest-based advertising, interest category marketing, content delivery based on demographic information, and content delivery based on previously-seen advertisements), advertisements based on interests associated with user identifiers as derived from their historical page views or other data sources may be developed. Without proper compensations, data providers may be unwilling to provide data. Without sufficient benefits, publishers may be unwilling to use user identifier data from other sources.

In addition to advertisements related to the current context of a webpage which the user identifier is currently viewing, advertisements can also be selected and shown on the current webpage based on user identifier interests derived from the user's historical page views or other data sources, for example from third-party data providers. In this case, the value to each advertisement impression may not come from the single webpage publisher where the advertisement is shown.

In one example scenario, a user identifier previously visited a high-quality travel site A. Based on this visit, it can be inferred that the user identifier may have an interest in travel. The user identifier later visits a fiction site B, which can show one or more contextual advertisements related to fictions. A cost of such contextual advertisements may be $1, for example. If the advertisements are no longer limited to contextual advertisements, a competitive travel advertisement C (such as an advertisement for a hotel) may now be shown on the fiction site B, based on the user identifier data (i.e., the user's previous interest in travel) provided from site A. Because the travel advertisement C may less relevant to the content of the site B (fictions), the cost for the advertisement may be higher, e.g., $1.2, resulting possibly from more bids since now the advertisements can include both contextual advertisements and user advertisements.

The user identifier may click the travel advertisement C on site B. In this case, site A may have provided the data value at $1.2−$1.0=$0.2, while site B provides a “media” value $1.0. With the conventional system, the provider of site B gets a full compensation of $1.2 from the advertiser (e.g., hotel manager), while the provider of site A unfairly gets no compensation. In other words, the provider of site B is over-paid for the portion of value it did not provide.

In one implementation, to create incentive for those data providers such as the owner of site A, an algorithm can be provided to separate data value and media value so that revenue can be shared between data providers and publishers.

Implementations disclosed herein help properly price data so that the supply of data can become more plentiful, and more data buyer may find the price of the data to be fair. A large amount of data can be used to help making a decision about what media to buy. Many different data components, such as browsing histories, time and geographic locations, and browsing habits etc., can be used together.

In some implementations, a co-op data model or co-promotion system can be provided, where only user identifiers and/or content providers that provide data into a system are allowed to use the system. A large pool of data inventory may thus be built relatively quickly. However, it may be difficult to attract the higher quality and more differentiated data into these co-ops. Direct mail advertisers frequently exchange subscriber lists in this way.

In some implementations, a flat-fee licensing can be provided, where a data provider may charge a flat-fee license for unlimited use of a particular data set. For example, an advertiser may pay $1,000/month to be able to obtain weather data at the zip code level, and use the data for a specific purpose. In another example, an advertiser may pay $100M for a lifetime license to obtain inferred interests for a given cookie that can be used on certain types of media. These flat-fee licenses may be negotiated in private, or posted in public, although private flat-fee licenses may allow data providers to handle the most price discrimination.

In some other implementations, a “per stamp” licensing may be provided, where a data provider may charge a flat fee license for unlimited use of particular data.

In some implementations, to more fairly compensate data providers, data value and media value may be determined separately out of advertisement cost, and the advertisement cost may be considered a sum of the data value and the media value. Based on such determined data values and media values, revenue can be shared between data providers and publishers/media providers proportional to the values they have provided.

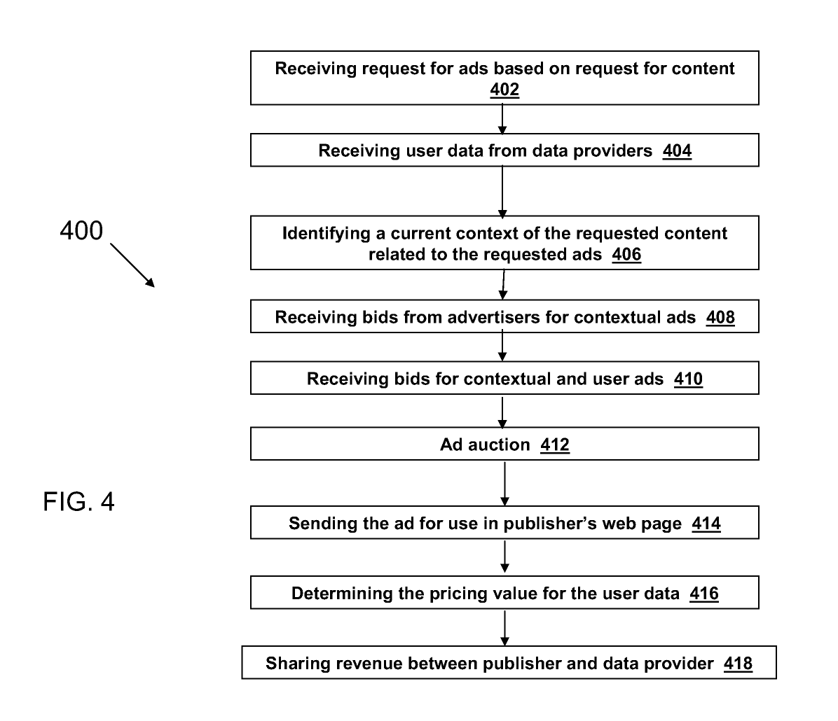

FIG. 4 is a flowchart illustrating a computer-implemented method 400 associated with the implementations disclosed herein. In an operation 402, one or more processing circuit of a computer system can receive one or more requests for alternative content based on a request for content. In an advertising environment, the request for content can be, for example, a user's opening a webpage published by a publisher, and the requests for alternative content can be requests from one or more advertisers to display their advertisements along the main content of the webpage at the publisher's website. The webpage can be a relatively static page, such as that illustrated in FIG. 2, or a rather dynamic page such as a search result page, as illustrated in FIG. 3.

In an operation 404, one or more processing circuit, which can be the same as or different from the one or more processing circuit for receiving the requests in operation 402, can receive user identifier data from one or more data providers. Such user identifier data can be, for example, user identifier browsing histories, and the data providers in this case would be the websites which the user identifier has previously browsed. In another example, the user identifier data may include user identifier demographic information, and the data providers can be some third-party data aggregators.

In an operation 406, one or more processing circuit may identify a current context of the requested content contextually related to the requested alternative content. In the advertising environment, this may involve identifying those websites having the content contextually related to the candidate advertisements, and these advertisements would be the contextual advertisements that are contextually related to the current context of the identified web pages. Despite of the terminology differentiation of “contextual advertisements” and the “user interest advertisements,” the contextual advertisements may also reflect the user identifiers' interests, e.g., the user identifiers' current interests at the time they visit certain websites or conduct searches with certain keywords. The “user interest advertisements” may refer to the user identifiers' past interests, as derived from their browsing history. Sometimes the phrase “user advertisements” may be used to refer to these user interest advertisements and other advertisements related to user identifier data (such as advertisements delivered to certain user identifier demographic or location groups).

Next, first alternative content based on the identified current context of the requested content may be selected, and a first cost of the first selected alternative content can be determined. In the advertising environment, these can be realized by receiving bids from advertisers for contextual advertisements only in a first auction process, as illustrated in operation 408 in FIG. 4. The cost of the winning ad(s) in the first auction may be considered as the media value, as the publisher (media provider) provides all the value, without needing other data.

Next, second alternative content based on the identified current context of the requested content and the user identifier data may be selected, and a second cost of the second selected alternative content can be determined. In the advertising environment, these can be realized by receiving bids from advertisers for all advertisements including both contextual advertisements and user advertisements, in a second auction process, as illustrated in operation 410 in FIG. 4. This second cost of winning ad(s) in the second auction process may be considered the overall advertisement cost.

In an advertisement auction operation 412, it may be determined whether the rankings of the advertisements are appropriate, taking into account for example the bids and the qualities of the advertisements. The qualities of the advertisements may be reflected in their relevancy to the current context or to the user identifier data. Such relevancy may be quantified mathematically using correlation scores.

The selected advertisements can then be sent for use in the publisher's web pages in an operation 414. Such advertisements can include both the contextual advertisements and the user advertisements, and their ranking may be a combined ranking of their correlations with the current context of the web pages and with the user identifier data.

In an operation 416, the pricing value of the user identifier data can be determined, for example, by subtracting the first cost (media value) from the second cost (overall advertisement cost). In an operation 418, the revenue from the advertisements can be shared between the publisher and the data provider based on the pricing value of the user identifier data.

This method may help more fairly compensate data providers, and create incentives for high-value publishers and data brands to contribute user identifier data to the system. Original data providers can have the ability to sell their data, through a plurality of channels or platforms, without relying on other data aggregates and third-party data platforms.

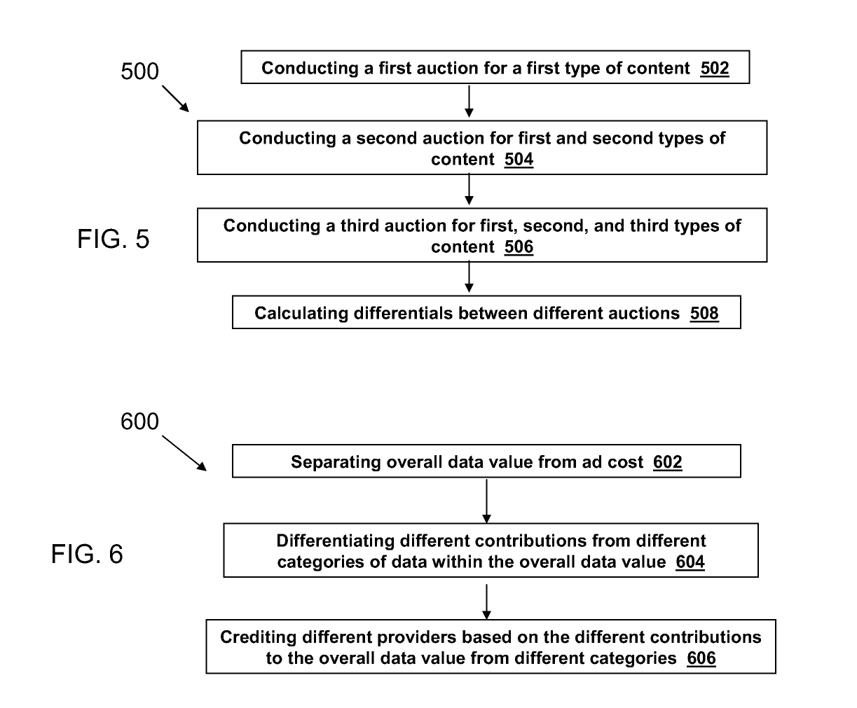

Although in the example described above only two auctions are conducted to determine the data value and the media value, in general a plurality of such layered auctions may be conducted to differentiate values contributed from different parties in the system. For example, in a method illustrated in the flowchart of FIG. 5, in operations 502 through 506, first, second, and third auctions may be conducted respectively for a first pool including a first type of content, a second pool including first+second types of content, and a third pool including first+second+third types of content. The differentials between layers of these auctions may be used to determine the contribution of each type of content in an operation 508.

In a first example, three full-slot advertisement candidates are selected and sorted by decreasing maximum eCPM order. These advertisement candidates include contextual advertisements (C_i) and user interest advertisements (U_i). Their respective providers (advertisers) would bid with the following bids:

C_{—}1(max_{—}eCPM=$10)

U_{—}1(max_{—}eCPM=$7)

C_{—}2(max_{—}eCPM=$5)

A first auction may be conducted excluding user identifier interest advertisement U_{—}1. In this case, the winner advertisement would be C_{—}1 with a maximum eCPM(C_{—}1)=$5. Thus, the media value may be determined to be $5.

A second auction may then be performed using all advertisements. The winning advertisement may be C_{—}1 again. However, in this case eCPM(C_{—}1)=$7, because the second highest bid (U_{—}1) may be $7. Thus, the advertisement cost may be determined to be $7.

The user identifier data value for this impression can then be determined as $7−$5=$2.

In another example, six advertisement candidates may be included:

C_{—}1(max_{—}eCPM=$10.0)

U_{—}1(max_{—}eCPM=$7.0)

C_{—}2(max_{—}eCPM=$5.0)

U_{—}2(max_{—}eCPM=$4.0)

C_{—}3(max_{—}eCPM=$4.0)

C_{—}4(max_{—}eCPM=$3.0)

The final winning advertisements may be C_{—}1, U_{—}1, and C_{—}2. If user interest advertisements are excluded, then contextual advertisements C_{—}1, C_{—}2, C_{—}3 would be shown. In these two scenarios, eCPM(C_{—}1, U_{—}1, C_{—}2)=$7.0+$5.0+$4.0=$16.0, and eCPM (C_{—}1, C_{—}2, C_{—}3)=$5.0+$4.0+$3.0=$12.0.

If C_{—}1 gets clicked, its advertiser may pay $8.0. The user identifier data value for this impression may be $8.0*(16.0−12.0)/16.0=$2.0.

The final advertisement impression value at the time of the auction may not be necessarily known. To achieve this per auction level estimation, the incremental % can be logged so that it could be used later for estimation. Such an incremental % would be (16.0−12.0)/16.0=25% in this example.

It may be noted that the advertisement quality signals are already included in the auction process, as in existing advertisement ranking and auction schemes. In addition, the user identifier data quality is also taken into account during the auction process. For example, user identifier data including both a user's historical browsing behaviors and the user's demographic information can be much more valuable than these data provided separately. Such a value may be reflected in that much higher bids may be received when these data are provided together. In one example, a user interest advertisement based on the user identifier's browsing history may have a maximum eCPM of $7, a user identifier interest advertisement based on the user's demographic information may have a maximum eCPM of $5, yet a user interest advertisement tailored based on combined information of the user's browsing history and demographic information may have a maximum eCPM of $16.

Table 1 shows that in one example, four websites are involved and will be sharing 70% of the total advertisement revenue (the remaining 30% may be retained by the advertisement system provider). Different scenarios are tabulated, including of earning revenues without user identifier data, with user identifier data, and net revenues without user identifier data, and with user identifier data.

TABLE 1

| | Rev. | Rev. | Net rev. | Net rev. |
|---|---|---|---|---|
| | w/o data | w data | w/o data | w data |
| A (/travel) | $600 | $600 | $420 | $420 |
| B (/travel) | $400 | $400 | $280 | $280 |
| C (/auto) | $800 | $900 | $560 | $630 |
| D (/fiction) | $200 | $300 | $140 | $210 |
| All Sites | $2000 | $2200 | $1400 | $1540 |

Table 1 illustrates that in one example allowing user identifier data may generate a total of $200 (10%) additional revenue. An assumption may be made for the actual user identifier value brought by each site as:

TABLE 2

| | User data value |
|---|---|
| | contribution |
| Site A | $75 |
| Site B | $75 |
| Site C | $50 |
| Site D | $0 |

Assuming that data providers contribute to 80% of the total revenue and media providers contribute 20% of the total revenue, the effective revenue share for the data providers would be 80%×70%=56%, and the effective revenue share for the media providers may be 14%. Table 3 shows revenue for each site after a revenue redistribution.

TABLE 3

| | Rev. w/o | Rev. w | Net rev. w/o | Net rev. as | Net rev. w |
|---|---|---|---|---|---|
| | user data | user data | user data | data provider | user data |
| Site A | $600 | $600 | $420 | $42 | $462 |
| Site B | $400 | $400 | $280 | $42 | $322 |
| Site C | $800 | $900 | $560 | $28 | $602 |
| Site D | $200 | $300 | $140 | $0 | $154 |
| All | $2000 | $2200 | $1400 | $112 | $1540 |
| Sites | | | | | |

After the adjustment, as data provider, Site A gets $75*56%=$42, Site B gets $75*56%=$42, Site C gets $50*56%=$28, and Site D gets $0. For advertisements shown on their respective own sites: Site A gets $600*70%=$420 (No gain from user identifier data); Site B gets $400*70%=$280 (No gain from user identifier data); Site C gets $800*70%+($900−$800)*14%=$574 ($14 gain from user identifier data); and Site D gets $200*70%+($300−$200)*14%=$154 ($14 gain from user identifier data).

In the above example, after the adjustment, the total payout to all sites ($1540) remains the same as in the conventional revenue sharing scheme, but is now redistributed. After the redistribution, Sites A, B and C all get compensated for providing user identifier data to other sites. Site C and Site D get less revenue for advertisements shown on their own sites, but they would still prefer to opt-in for user identifier data, since they both benefit from user identifier data (more revenue as compared to opt-out user identifier data).

In addition to the layered auction method described above, other approaches may be used to estimate how much data value the data providers add to the system. In general, only the additional value they bring in to other sites may need be estimated, as the value they bring to their own sites have been well compensated since they are the publishers in this case.

In one implementation, the data value can be estimated at an aggregate level. For example, an online experiment can be performed to turn off all user identifier signals to obtain an estimate of the overall incremental gain of using user identifier data. In a prophetic example, by running the experiment, it can be estimated that the total revenue without using user identifier data may be $2000, and with user identifier signals the total revenue may be $2200. Thus, the aggregate user identifier data value can be derived to be about $200, or 10% of overall revenue.

In another approach, data value can be estimated at per category level. An aggregate user identifier value of a given category v can be defined as the total revenue generated from advertisements in v when they are shown on a page in a different category v′. For instance, if a travel advertisement is shown on a non travel site, the advertisement revenue can be attributed to category/travel, and can be aggregated. The following Table 4 illustrates an example of per-category data attribution.

TABLE 4

| | Total rev. | Total rev. | Aggre- | Contri- | Attrib- | |
|---|---|---|---|---|---|---|
| | w/o user | w user | gated data | bution | ute data | |
| | data | data | value | factor | value | x_v% |
| /travel | $1000 | $1000 | $300 | 0.75 | $150 | 15% |
| /auto | $800 | $900 | $100 | 0.25 | $50 | 6.25% |
| /fiction | $200 | $300 | $0 | 0.0 | $0 | 0.0% |

In the example above, the computed aggregate data value for /travel is $300, /auto is $100, and /fiction is $0. The overall $200 user identifier data value can then be partitioned and attributed to each category as: $200*0.75=$150 to /travel category, $200*0.25=$50 to /auto category, and $200*0.0=$0 to /fiction category.

The effective incremental % of revenue brought to the system can be further computed in each category: x_travel %=$150/$1000=15%, x_auto %=$50/$800=6.25%, and x_fiction %=$0/$200=0.0%.

In this approach, more fine-grained data attribution can be obtained at per category level. The contribution factor as computed may be considered an estimate, as when aggregated data values for v were calculated, the alternative advertisements values were not subtracted.

Various approaches may be used to identify user advertisements that actually use user identifier data. This may sometimes be difficult to achieve because user identifier data may be mixed with document data.

In some implementations, interest category marketing advertisements may be identified. In an example, advertisement type identified with a specific identifier, and condition that the delivery criteria≠current document categories are used to identify whether the advertisement is an interest category marketing advertisement.

In some implementations, advertisements based on previously-seen advertisements are identified.

In some implementations, an approximation may be adopted, and advertisement categories and page categories are compared. If they do not match, then the advertisement may be considered a user advertisement.

In the above implementations, advantageously user advertisements values can be identified at per auction level, more fine grind data value attribution can be performed in the future, and data attribution report can be generated at advertisement impression level.

In some of the implementations however, some auction code changes may be needed, and auction logics may need to be run for a plurality of times, e.g., with and without user advertisements, in real-time to find out the incremental % value. Additional fields may need to be logged for this analysis. Some efforts may also be needed to find out which advertisements to skip, for example in a case where the same advertisement may appear in multiple advertisement blocks (e.g., more than one “sponsored links” block shown in FIG. 2) in same page.

In some cases, it may be difficult to differentiate user interest advertisements from contextual advertisements. User identifier signals can be mixed with document signals, making it difficult to determine whether an advertisement is a pure user advertisement. In the auction process, if user identifier signal is not used, advertisements retrieval/scoring would be affected as well.

The methods described above can separate data value from media value. However, data attribution among the data providers may still be needed to more correctly credit and fairly compensate the data providers individually.

In an example method 600 illustrated in the flowchart of FIG. 6, first in an operation 602 the overall data value can be separated from the overall advertisement cost. This can be achieved using the methods described in the previous sections. In an operation 604, different contributions from different categories of data are further differentiated within the overall data value. A number of approaches can be used to achieve this, as described in detail below. In an operation 606, different providers can be credited based on the different contributions to the overall data value from different categories of data.

In a first approach, a fixed x % of the revenue is paid to all data providers no matter how much they finally provided. This attribution approach may be implemented if the first data value estimation approach described in the previous section is used.

If the incremental gain for using all data is 10%, then the overall compensation for data providers for their contribution of the user identifier data may be 7% of total revenue (after a 70% revenue share with publishers). In all data providers contribute user identifier data in proportion to the revenue they can get on their own sites (with an assumption that the more a data provider generates revenue from their own sites as publishers using their own data, the more valuable their data may be to other sites), then a fixed x % revenue given to each data provider may be considered relatively fair.

Continuing with the previous example, assuming a fixed 5.6% revenue given to data providers, after the adjustment, the revenue distribution may be similar to the example shown in the following Table 5.

TABLE 5

| | Rev. w/o | Rev. w | Net rev. as | Net rev. w/o | Net rev. w |
|---|---|---|---|---|---|
| | user data | user data | data provider | user data | user data |
| Site A | $600 | $600 | $33.6 | $420 | $453.6 |
| Site B | $400 | $400 | $22.4 | $280 | $302.4 |
| Site C | $800 | $900 | $44.8 | $560 | $618.8 |
| Site D | $200 | $300 | $11.2 | $140 | $165.2 |
| All | $2000 | $2200 | $112 | $1400 | $1540 |
| Sites | | | | | |

With this approach, the total compensation for data providers is the same ($112 in the example) as in the case of Table 3, and the compensation to each data provider is a simple function of the data provider's revenue without using user identifier data: Site A gets $600*5.6%=$33.6; Site B gets $400*5.6%=$22.4; Site C gets $800*5.6%=$44.8; and Site D gets $200*5.6%=$11.2.

Advantageously, this approach may be considered quite simple, and may not require any code changes.

However, the approach may include relatively strong assumptions, and as is shown in the example, the final compensations may not be very accurate. From reporting point of view, data providers may not be able to get per advertisement impression report. The x % may be computed based on current overall incremental value of user identifier data and applied to all data providers. If the number of real data providers and data receivers is highly skewed, (e.g., too many sites resembling site D), this approach may end up paying very little to the real data providers.

In another approach, a fixed x_v % of the revenue may be paid to all data providers in category v. If data value is estimated at category level, then more fine-grained x_v % may be obtained as shown in Table 4. The 70% revenue share can be applied to obtain the effective x_v %: x_travel %=15%*70%=10.5%, x_auto %=6.25%*70%=4.375%, x_fiction %=0.0%*70%=0.0%.

With this modification, the final attributed data provider value to each site may become: Site A=$600*10.5%=$63; Site B=$400*10.5%=$42; Site C=$800*4.375%=$35; Site D=$0.

In a third approach, data attribution may be performed at per auction level. As described earlier, with some code changes, per auction user identifier data value can be estimated. In the previous example, such a value is determined to be $2.0 in a given auction. Different approaches may be employed to identify data providers for that auction.

If the advertisement that was clicked is an advertisement delivered to selected users based on previously-seen advertisements, which pages the user identifier visited before the current page matches the category of the clicked advertisement may be apparent, and the attribution may have the following options: 1) Attribute to the most recent website which the user identifier has visited and whose category matches the clicked advertisement category. 2) Evenly attribute to all websites which the user identifier has visited and whose category matches the clicked advertisement category. 3) Attribute to websites proportional to the number of page views which the user identifier had and which matches the advertisement category. 4) Attribute to websites proportional to the revenue which the websites can earn on their own.

In one example, the above option 3) may be used for data attribution, where a user identifier had 15 page views about /travel on site A and 5 page views about /travel on Site B, and then clicked a /travel advertisement on a /fiction site D. In this case, both sites A and B have contributed to the advertisement impression. For a $2.0 total revenue, after the 70% revenue share with the advertisement system provider, there are $0.6 left. Site D may share a portion, e.g., 20%, as the media provider, and there is $0.48 left to compensate sites A and B.

Site A may get a share of $0.48*15/20=$0.36, and Site B may get 0.48*5/20=$0.12.

If the clicked advertisement is an ICM advertisement and if the data providers are third party data providers, the following approaches may be used to attribute third party data providers: Determining and ranking data providers' quality for each interest category offline. Combining multiple data providers' data into user identifier profile at serving time and attribute all credit for a given interest category to the data provider with the highest quality score.

The same approach may continue to be used for data providers who are not in the network, and for large publishers who are also data providers in the network.

This approach may have a scalability issue. With more and more data providers opt-in, it may become difficult to get sufficient data to evaluate data quality for everyone. At that stage, simpler strategies similar to the ones described for CUBAQ advertisements may be adopted.

The above description discloses how a search engine provider may identify data value and attribute to data providers. The media providers may share some of their revenue to data providers, but with benefits of improved advertisement delivering by encouraging the data providers to share user identifier data. In one implementation, a new revenue sharing formula for an advertisement impression can be expressed as a function of the “old” revenue sharing:

r_new=r_old*(1−y%)*70%+r_old*y%*(70%−x%).

Here y % may indicate the incremental % for showing user advertisement, and x % may indicate the portion used to pay the data providers.

If y=0 (e.g., no gains from user advertisements), r_new=r_old*70%.

If y=1 (e.g., 100% gains from user advertisements), r_new=r_old*(70%−x %).

A significant portion of the revenue, e.g., (70%−x %), may still be shared with the media providers, to give them sufficient incentives to allow user advertisements to appear on their sites.

FIG. 7 is a high-level block diagram of a computer-based system 700 that may perform one or more of the operations discussed above. The system 700 may include a processor or processing circuit 710, an input/output interface unit 730, a storage device 720, and a system bus or network 740 for facilitating the communication of information among the coupled elements. An input device 732 and an output device 734 may be coupled with the input/output interface 730.

The processor 710 may execute machine-executable instructions stored on, for example, a computer-readable storage medium to perform one or more aspects of the present disclosure. At least a portion of the machine executable instructions may be stored (temporarily or more permanently) on the storage device 720 and/or may be received from an external source via an input interface unit 730. The computer-readable storage medium does not include a transitory signal.

The one or more input and/or output devices 750 may include a communication device for operable connection with a network 160 and with the other components of the system 100 as illustrated in FIG. 1. The one or more computer systems 700 can perform the various functions of the components of the system 100 by executing computer-readable instructions, such as computer software stored on a computer-readable storage device.

In some implementations, the user identifier terminal 111 as illustrated in FIG. 1 may be part of the system 700 or may be connected to the system 700. The user identifier terminal 111 may include one or more conventional personal computers, including one or more of a mobile device, a smart phone, a personal digital assistant (PDA), a tablet computer, or a camera that can connect to the system 700 or to the Internet.

Other devices that can be used for various implementations of the disclosure may include, for example, a smart television module (or connected TV module, hybrid TV module, etc.). The user identifier can select content to view of the smart TV, and the selected content may come with various advertisements contextually related to the selected content or related to the viewer's interests based on user identifier data.

The smart TV may include a processing circuit configured to integrate internet connectivity with more traditional TV programming sources (e.g., received via cable, satellite, over-the-air, or other signals). The smart TV module may be physically incorporated into a TV set or may include a separate device such as a set-top box, Blu-ray or other digital media player, game console, hotel TV system, and other companion device.

A smart TV module may be configured to allow viewers to search and find videos, movies, photos and other content on the web, on a local cable TV channel, on a satellite TV channel, or stored on a local storage device. A set-top box (STB) or set-top unit (STU) may include an information appliance device that may contain a tuner and connect to a TV set and an external source of signal, turning the signal into content which is then displayed on the TV screen or other display device.

A smart TV module may be configured to provide a home screen or top level screen including icons for a plurality of different applications, such as a web browser and a plurality of streaming media services, a connected cable or satellite media source, other web “channels”, etc. The smart TV module may further be configured to provide an electronic programming guide to the user identifier. A companion application to the smart TV module may be operable on a mobile computing device to provide additional information about available programs to a user, to allow the user identifier to control the smart TV module, etc.

The processor 710 may be one or more microprocessors. The bus 740 may include a system bus. The storage device 720 may include system memory, such a read only memory (ROM) and/or random access memory (RAM). The storage device 720 can include any suitable type of storage including, for example, a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or any other type of storage medium.

A user identifier may enter commands and information into the personal computer through input device 732, such as a keyboard and pointing device (e.g., a mouse) for example. Other input devices such as a microphone, a touch input interface, a joystick, a game pad, a satellite dish, a scanner, or the like, may also (or alternatively) be included. These and other input devices can be connected to the processor 710 through an appropriate interface 730 coupled to the system bus 740.

The output device 734 may include a monitor or other types of display devices, which can be connected to the system bus 740 via an appropriate interface. In addition (or instead of) the monitor, the personal computer may include other (peripheral) output devices (not shown), such as speakers and printers for example. In some cases, output device 734 can include a component for providing one or more of a visual output, a haptic output, or an audio output.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the disclosure can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A computer-implemented method comprising:
receiving, by at least one processing circuit, a request for alternative content based on a request for content;
receiving, by at least one processing circuit, user identifier data from at least one data provider;
selecting, by at least one processing circuit, at least one first alternative content from a first pool of alternative content that is contextually related to the requested content;
determining a first cost of the at least one first alternative content;
selecting, by at least one processing circuit, at least one second alternative content from the first pool, and from the second pool of alternative content that is related to the user identifier data;
determining a second cost of the at least one second alternative content; and
determining a pricing value of the user identifier data based on a difference between the second and the first costs.

2. The computer-implemented method of claim 1, further comprising rewarding the data provider based on the determined pricing value of the user identifier data.

3. The computer-implemented method of claim 2, wherein said rewarding comprises sharing a revenue between the at least one data provider and at least one publisher that publishes the second alternative content together with the current context of the requested content.

4. The computer-implemented method of claim 3, wherein the at least one second alternative content comprises at least one of:
a contextual advertisement related to the requested content; or
a user advertisement related to past user identifier interests based on the user identifier data.

5. The computer-implemented method of claim 4, wherein the at least one first alternative content comprises at least one contextual advertisement contextually related to the requested content as published on the publisher's website, and wherein said determining a first cost comprises conducting a first auction for at least one advertising slot on the publisher's website among the first pool.

6. The computer-implemented method of claim 5, wherein the at least one second alternative content comprises:
at least one contextual advertisement; and
at least one user advertisement,
and wherein said determining a second cost comprises conducting a second auction for the at least one advertising slot on the publisher's website among the first and second pools.

7. The computer-implemented method of claim 6, further comprising differentiating different contributions from different data providers among a plurality of data providers.

8. The computer-implemented method of claim 7, wherein said differentiating is based on different categories of user identifier data.

9. The computer-implemented method of claim 8, wherein said differentiating comprises a plurality of layered auctions based on the different categories of user identifier data.

10. The computer-implemented method of claim 9, wherein the different categories of user identifier data comprise a first category of user identifier data derived from user identifier browsing histories, and a second category of user identifier data derived from user identifier demographic information.

11. The computer-implemented method of claim 1, wherein the first cost represents a media value provided by at least one publisher that publishes the at least one second alternative content together with the current context of the requested content.

12. The computer-implemented method of claim 11, wherein the at least one second alternative content comprises at least one advertisement, and wherein the second cost represents and overall advertisement cost.

13. A computer system for performing an auction for at least one advertisement slot on a web page published by a publisher, the system comprising:
at least one processing circuit connected to a network, the at least one processing circuit configured to:
receive a request for advertisements based on a request for the web page;
receive user identifier data from at least one data provider;
conduct a first auction among a first pool of advertisements, wherein the first pool of advertisements are selected based on their contextual relevance to the web page;
determine, based on the first auction, a media value provided by the publisher;
conduct a second auction among the first pool and a second pool of advertisements, wherein the second pool of advertisements are selected based on the user identifier data;
determine, based on the second auction, an overall advertisement value provided by both the at least one data provider and the publisher; and
determine a pricing value of the user identifier data based on a difference between the overall advertisement value and the media value.

14. The computer system of claim 13, wherein the web page comprises a substantially static main content, and wherein said request for the web page comprises loading the web page to a user identifier terminal.

15. The computer system of claim 13, wherein the web page comprises a dynamic search result page, and wherein said request for the web page comprises a search query.

16. The computer system of claim 15, wherein the web page publisher is a search engine provider, wherein the search engine provider also acts one of the at least one data provider, and wherein the user identifier data comprise user identifier search histories.

17. The computer system of claim 13, wherein the at least one data provider comprises a plurality of different data providers providing a plurality of different categories of user identifier data, and wherein the at least one processing circuit is further configured to differentiate different contributions to the user identifier data value from the different data providers.

18. The computer system of claim 17, wherein the at least one processing circuit is further configured to conduct a plurality of layered auctions based on the different categories of user identifier data to thereby differentiate the different contributions to the user identifier data from the different data providers.

19. The computer system of claim 18, wherein the plurality of different categories of user identifier data comprise a first category of user identifier data derived from user identifier browsing histories, and a second category of user identifier data derived from user identifier demographic information.

20. A computer-readable storage medium having instructions stored thereon which, when executed, cause at least one processing circuit to perform an auction for at least one advertisement slot on a web page published by a publisher, the instructions comprising:
receiving a request for advertisements based on a request for the web page;
receiving user identifier data from at least one data provider;
conducting a first auction among a first pool of advertisements, wherein the first pool of advertisements are selected based their contextual relevance to the web page;
determining, based on the first auction, a media value provided by the publisher;
conducting a second auction among the first pool and a second pool of advertisements, wherein the second pool of advertisements are selected based on the user identifier data;
determining, based on the second auction, an overall advertisement value provided by both the at least one data provider and the publisher;
determining a pricing value of the user identifier data based on a difference between the overall advertisement value and the media value;
displaying the web page including at least one advertisement based on the second auction; and
sharing a revenue from said displaying between the publisher and the at least one data provider.
